(19) United States
(12) Patent Application Publication
(10) Pub. No.: US 2005/0259055 A1
(43) Pub. Date: Nov. 24, 2005

(54) Pixelized driving means for cholesteric display

(76) Inventor: Yao-Dong Ma, San Jose, CA (US)

Correspondence Address: YAO DONG MA, 14586 PENSHAM DR., FRISCO, TX, 75035, US

(21) Appl. No.: 10/295,611

(22) Filed: Nov. 15, 2002

(51) Int. Cl. G09G 3/36

(52) U.S. Cl. 345/87

(57) ABSTRACT

A pixelized driving means for cholesteric liquid crystal display comprises driving waveforms and related circuitry employing one voltage level. The first pulse with a voltage level and sufficient pulse duration can erase a single pixel to the planar texture; while the second pulse with the same voltage level but relatively short pulse duration will be able to address a single pixel to the focal conic texture. Though the pulse-height and the pulse-width are fixed as required, the number of the pulses can be digitally controlled. Thus, the driving means generates a unique solution for selectively activating an element of the display into a designated optical state without any visual impact on the rest elements.

### FIELD OF INVENTION

This invention relates to a LCD driving means, especially to cholesteric display driving waveforms and a relavent circuitry employing one voltage level. The waveforms and circuitry generate a unique pixelized solution for selectively addressing a single element of the display without any visual impact of the rest elements.

### BACKGROUND OF THE INVENTION

Cholesteric liquid crystal is the earliest mesomorphic state of matter known to humankind. Cholesteric liquid crystal display (ChLCD) is a sort of Cinderella in the liquid crystal family, an old but state-of-the-art technology that started 30 years ago when people found Electric Field Induced Phase Change Effect of the cholesteric liquid crystal displays. It is characterized by the fact that the pictures may stay on the display even if the driving voltage is disconnected. The bistability also ensures a completely flicker-free display and has the possibility of infinite multiplexing to create giant displays and/or ultra-high resolution displays. The Bragg scattering effect makes ChLCD the best candidate for the reflective color display if the pitch of the CHLC is chosen in the range of visible wavelength. However, for the reasons of high driving voltage, especially the high instant driving power consumption and slow driving means, which make it impossible for the animation display and thereafter the poor electro-optical performance. Therefore, it has been replaced by other displays such as twist nematic (TN) and super twist nematic (STN). Almost no one has mentioned about the cholesteric LCD until recent years' discovery of new display modes and improvements of the driving methods.

In the article of Storage-Type Liquid Crystal Matrix Display (SID 79 Digest, p. 114-115) Tani proposes a driving method for the ChLCD. The display adopts a vertical alignment treatment and the liquid crystal pixel can be driven from stable planar structure to stable focal conic structure or from stable focal-conic structure to stable planar structure depending on the pre-designed waveform. The storage type display has the advantages of long storage time, which makes refreshing or updating of the information on the display unnecessary. However the scanning speed is relatively slow and each line needs 8 ms to address the pixels and the information can not display till the whole frame scanning is accomplished. The power consumption is high because of the two phase change voltages to the non-selection pixel and multi driving pulse sequence are over the phase change (untwist threshold) voltage.

U.S. Pat. No. 5,644,330 introduces a driving method based on static electro-optical curve of ChLCD by defining V₁ as the first threshold voltage; V₂ as the first saturate voltage; V₃ as the second threshold voltage; and V₄ as the second saturate voltage. The voltage sequence or driving waveform could drive the display from one cholesteric stable state to the other. A pulse higher than V₄ can drive the display into planar state while a pulse V₄ and followed by a pulse between V₂-V₃ will drive the display into the focal-conic state. Though the static driving principle is the same as Tani's approach, “330” teaches two bipolar square waveforms exerting to X,Y electrodes separately. When the two bipolar waveform is out-phase, the resultant voltage will be high enough to drive the display to planar state while the in-phase resultant voltage will drive the display into the focal conic state instead. Again the driving waveform is based on the static approach, i.e., the pulse width should be wide enough to drive the display from one stable state to the other stable state. As a result the scanning speed is very slow.

U.S. Pat. No. 5,748,277 divides the information writing into three stages, i.e., preparation, selection and evolution. In the first preparation phase, a pulse or series of pulses causes the liquid crystal within the picture element to align in homeotropic state and the display looks dark. The second stage is named selection step, during which the voltage added to the liquid crystal within the picture element is chosen so that the final optical state of the pixel will be either focal conic or twisted planar. In practice, the voltage is chosen to either maintain the homeotropic state or reduced enough to initiate a transition to the transient twisted planar state. The third stage is evolution step, during which the liquid crystal selected to transform into the transient twisted planar state during the selection step now evolves in a focal conic state and the liquid crystal selected to remain in the homeotropic state during the selection phase continues in the homeotropic state. The voltage level of the evolution phase must be high enough to maintain the homeotropic state and permit the transient planar state to evolve into the focal conic state. After evolution stage, there comes actually holding stage where the voltage is taken to near zero or removed entirely from the pixel. The liquid crystal domains that are in the focal conic state remain in the focal conic state and those in the homeotropic state transform into a stable light reflecting planar state. In other words, the information cannot be recorded till the completion of the holding stage. The bipolar waveform makes the driver circuitry very complicated and long time in maintaining homeotropic state by multiple high voltage pulses which cause the power consumption relatively high and the display takes on dark background.

U.S. Pat. No. 5,625,477 teaches a driving means of whole frame erasing and line to line addressing. The waveform for the erasing stage consists of two pulses: first high voltage and followed by a low voltage pulse. The first high voltage pulse, which is higher than the phase change voltage, induces the whole panel pixels into the field-induced-nematic state. Sequential low voltage pulse then guides the liquid crystal molecules of whole display panel from nematic state back to the stable cholesteric focal conic state or optical dark state because the display is painted black. After the whole frame is driven to dark state, there comes addressing stage. A second high voltage, which is over the phase change threshold voltage, is selectively added to the pixels into planar bright state. While the second high voltage pulse is applying to each pixel to be addressed, a second low voltage pulse is also applied to all the others during the line-to-line addressing. The driving means takes advantage of fast process from focal conic structure to the field-induced-nematic structure, then to the reflective planar structure, thus achieves fast driving speed. However, the fact that the information writing needs two high voltages, which is higher than the phase change threshold causes high power consumption. Furthermore the display works in a negative mode, i.e., write-bright-on-dark, a way of blackboard writing, therefore the black bar effect is inevitable for the large information content display. From human factor viewpoint, the reflective type display should be write-black-on-bright, a way of paper writing in order to maximize the display merit of environment light reflection. Such paper-writing mode is so popular that almost any liquid crystal panel with black bars is unacceptable. Another shortcoming of frame-erasing-line-to-line-addressing is that it cannot be used as word editing, typewriting, or other instant input functions.

In the case of character writing display, according to different format, roughly more than half of the lines as spacing area doesn't need to be erased or recorded in the driving process. The frame-erasing-line-to-line addressing is not the best solution because of its slow driving speed (each line needs a minimum scanning time Tₛ and the frame scanning time T_{F} which is equal to Tₛ times number of the lines).

The basic formula (V_{R}−V_{S})/2=V_{N}<V_{T} tightly links three pulses, V_{R}, V_{S} and V_{N} together, which limits the effective addressing window. For example, if V_{R} needs to be increased to gain fast switching speed, V_{N} is also increased, which causes the cross-talk effect.

In the U.S. Patent application with the application Ser. No. 10/040,078, the applicant provide a partial addressing method for the cholesteric display, herein incorporated by reference. A localized driving means for cholesteric liquid crystal display comprises a high erasing pulse; a low addressing pulse and a series bias voltage pulses with its amplitude not less than the planar to focal conic threshold voltage. The erasing pulse and the addressing pulse, superimposed to the bias pulses respectively, are applied to a predetermined locations at the same time. The driving means is capable of directly writing the information without extra erasing time. In other words, regardless the optic state of the background, the new frame's information will be addressed onto the display panel within a short time period. In terms of the localization degree of such method, it has been successfully approved to partially drive the display in single-scan-line level with two-way rewriting, i.e., either from focal conic texture to planar texture or vise versa. It can also drive a single pixel into planar texture with the condition of all the pixels in the same scanning line are preset in focal conic background.

In summary, one of the unresolved questions of the passive-mode cholesteric display in the prior art until the present invention is to erase a pixel from focal conic texture to planar texture while remaining the rest pixels intact.

### SUMMARY OF THE INVENTION

It is the primary objective of the invention to achieve a pixelized driving scheme for cholesteric liquid crystal display, which erases and addresses the information in the unit of a single display pixel.

It is the other objective of the invention to use only one voltage level across the driving means to perform both erasing and addressing functions.

It is another objective of the invention to take advantage of the static electro-optical curve of cholesterics to generate optical on waveform.

It is still another objective of the invention to utilize the quarsi-static electro-optical curve of cholesterics to generate optical off waveform.

It is again the other objective of the invention to combine cholesterics static electro-optical curve with dynamic electro-optical curve to realize static erasing and dynamic addressing waveforms.

It is still another objective of the invention to obtain cross-talk-free pixelized erasing wherein only the designated pixel or pixels can be effectively erased and all other pixels will remain in their original optical state.

It is another objective of the invention to obtain multiple gray-scale of an imaging display.

It is a further objective of the invention to use pulse-number digitized modulation to achieve all above-mentioned optical states.

It is another objective to formulate an equation, V_{AD}=V_{AQ}=V_{ES}=3V_{N}, to govern synthesizing of the DC-free driving waveforms via X and Y drivers.

It is still another objective to design a related electronic circuitry to carry out the driving means.

### BRIEF DESCRIPTION OF DRAWING

FIG. 1 illustrates electro-optical curves of static driving and dynamic driving of a cholesteric liquid crystal display.

FIG. 2 illustrates a waveform of a static electrical driving scheme.

FIG. 3 illustrates the driving method and display result of a pixelized erasing.

FIG. 4 illustrates a waveform of a quarsi-static electrical driving scheme.

FIG. 5 illustrates the driving method and display result of a pixelized addressing.

FIG. 6 illustrates waveforms of a partial erasing and addressing driving scheme.

FIG. 7 illustrates the driving method and the display result of the partial erasing and addressing.

FIG. 8 illustrates the divisional circuitry of the displays X and Y drivers.

### DETAILED DESCRIPTION OF DRAWING

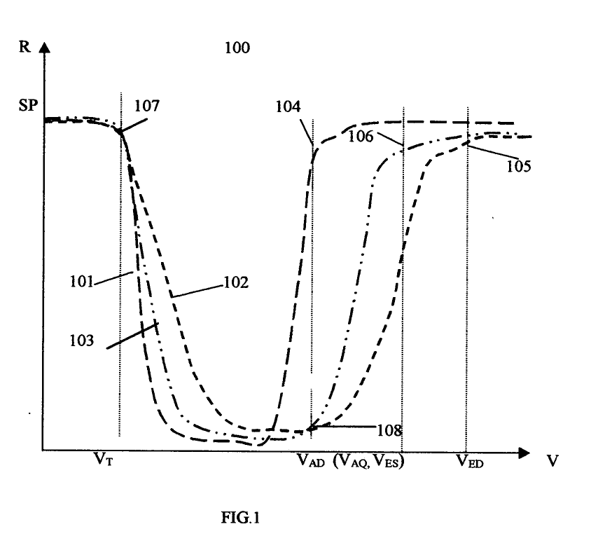

First referring to FIG. 1, illustrated is electro-optical curves of a cholesteric liquid crystal display. It represents optical response (reflectivity) to the electric pulses. Starting from undisturbed planar structure and zero voltage, a series of electric pulses with different pulse number are applied on the display area with an incremental scale-up. Thus the responsive reflection will generate a group of curves. The E-O curve 101 represents a optical response in a static driving condition, under which the total pulse duration, the reproduction of single pulse width and pulse number, is normally longer than 100 ms. Similarly, curve 102 presents an optical response in a dynamic driving condition with the pulse duration in the range of 0.05˜5 ms, normally in the range of 0.5˜2 ms. Between the static and dynamic driving curves 101 and 102, there is another curve 103 named quarsi-static electro-optical curve with the pulse duration between the static and dynamic driving, for example 20 ms. It is obvious that the electro-optical behaviors of the cholesteric display, under different driving conditions, can be quite different. In the case of the static driving, the curve 101 can be predicted by a theoretical calculation. The transition voltage, V_{T}, also called Grandjean voltage, is a result of the field induced rotations of the helical axes from cholesteric planar texture to focal conic texture. The field induced nematic voltage, V_{ES} 104 is a static threshold field at which the cholesteric molecules are transformed into a nematic structure, which is approximately given by a formula
V_{ES}=2π²/p₀(πK₂₂/Δε)^{1/2} (1)
where K₂₂ is the elastic modulus for twisting, Δε is the anisotropy in the dielectric constant, and p₀ denotes the zero field pitch of the helix. It is based on some given conditions of the elastic modulus of the cholesteric material that the following formula can be derived
V_{ES}≈3V_{T} (2)
which is in accordance with the curve 101.

However, in the dynamic driving condition, when the display cell is driven by short electric pulse, the electro-optical curve becomes 102. The field induced nematic voltage, V_{ED} 105, is no longer in accordance with the traditional expression. The voltage required to drive the display into planar state increases when the width of the applied pulse is decreased. Molecular behavior during the short pulse application is no longer just the untwist from focal conic state to the nematic state. Beside of the elastic modulus, the viscosity of the cholesteric material also plays an important role that causes much more impedance to the dynamic driving. The curve 102 looks shallower and wider than 101 with the field induced nematic voltage much higher than that static one. Between the curve 101 and 102, there will be many curves generated depending on the pulse duration. Take the curve 103, for example, its field induced nematic voltage 106 is just falling in the middle of 104 and 105.

Note, there is no a clear definition of the pulse width in static driving means. In the certain circumstances, the pulse width could be short to drive the cholesteric display from one stable state to the other stable state. As a matter of fact, certain factors such as the surface condition and polymeric network etc. could shorten the pulse width.

On the other hand, the field induced rotation voltage V_{T} 107 will be remained approximately unchanged despite of variation of the pulses width.

In the U.S. patent application of dynamic-relaxation driving means for cholesteric liquid crystal displays with the application Ser. No. 10/012,857, the applicant devised the following equation
V_{A}=3V_{T} (3)
herein incorporated by reference. The equation is also valid for the current invention and V_{A} 108 will be the dynamic and the quarsi-static addressing voltage for the novel driving scheme. The difference between the dynamic-relaxation driving means and the current invention is that the latter utilized only one working voltage across the driving scheme, which is governed by the following equation
V_{ES}=V_{AD}=3V_{T}. (4)

It is not difficult to realize that the erasing voltage 104 in the current invention will be much lower than the dynamic erasing voltage 105 with the trade-off of the longer pulse duration. The present invention introduces an important voltage equation, which not only unify the voltage level but also realizes pixelized erasing and addressing of the cholesteric display. Now that we have reach the condition that the phase change voltage V_{ES} in static driving curve and the addressing voltage V_{AD} in the dynamic driving curve are in the same level, it is feasible to design a new driving method, a pixelized driving means. Such driving means is characterized by the following aspects:

1. Static erasing and dynamic addressing Even though the erasing time is in the range of 100 ms, it is applicable in the partial revision or writing process. Overall, it will be much faster than that whole frame erasing and line-to-line addressing process of the prior arts. Furthermore, it is a revolutionary change to adopt a touch panel or a mouse pad to the storage-type display screen to carry out all the word processing functions in a reasonable fast speed.

2. Both the erasing and addressing have the same voltage level and the same pulse width but different pulse duration. The same voltage simplifies the electric power supply and eliminates the charge and discharge process during the voltage conversion from erasing to the addressing.

3. Either erasing or addressing can be two-directionally pixelized. The information on the display can be partially changed based on one pixel, one character or one paragraph.

4. The cross-talk voltages in the erasing and addressing are the same as or below the voltage V_{T}. A special cholesteric liquid crystal material needs to be formulated.

5. The equation, V_{ES}=V_{AD}=3V_{T}, ensures a cross-talk-free circuitry design.

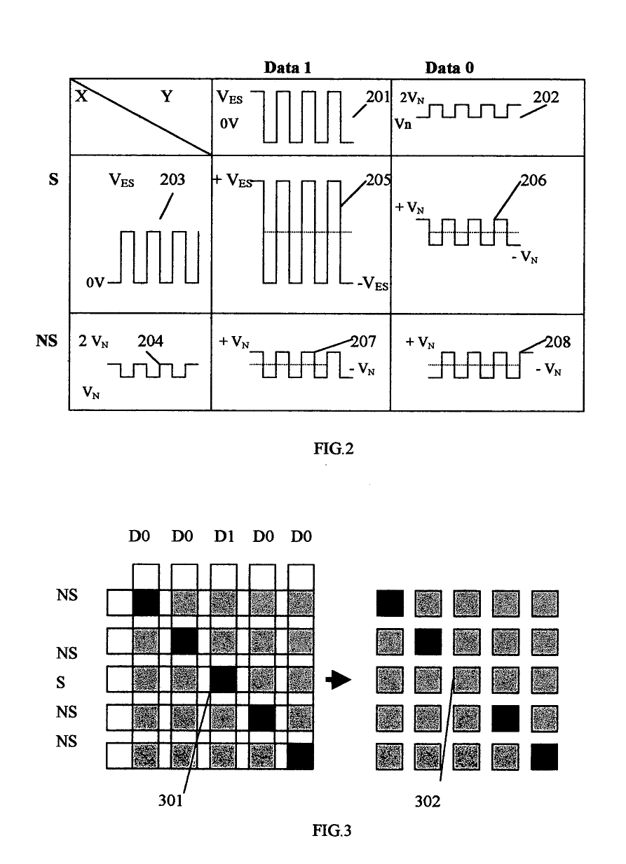

Turning now to FIG. 2, illustrated is the driving waveform of pixelized erasing of the present invention. There are two DC pulses generated from display's Y driver, Data 1, 201 and Data 0, 202. The amplitude of the Data 1 is equal to V_{ES} and the width of it is kept constant within the range of 0.05˜2 ms while the duration of the pulses is in the range of 20˜200 ms. The amplitude of the Data 0 is chosen between 2V_{N} and V_{N} and the width and the duration are the same as the Data 1. For the sake of easier explanation in the driving waveform, the non-selected voltage, V_{N}, will replace the voltage VT. Let us set the equation
V_{N}≦V_{T} (5)

Both the Data 1 and 0 are led to column electrodes controlled by the Y driver. There are also two DC pulses generated from display's X driver connected to the row electrodes, Selected pulse, 203 and Non-selected pulse, 204. Selected pulse is chosen to be the same as the Data 1 pulse but kept out-phase with the Data 1. Similarly, Non-selected pulse is chosen to be the same as the Data 0 pulse but kept out-phase with the Data 0. Both the Selected pulse and Non-selected pulse are led to the row electrodes controlled by the X driver. The voltage across a pixel is the DC-free AC voltage resulting from the difference between the respective column and row. The voltage across the pixels in the selected row is either V_{ES} pulse, 205 or V_{N} pulse, 206. The voltage across the pixels in the non-selected row is V_{N} pulse, 206. As a result, the pixel across the Data 1 column and the selected row will be addressed to planar texture. In other word, the Data 1 DC waveform out of Y driver and the DC waveform on selected row are of the same pulse height but opposite in phase and composites a AC waveform 205 which drives the pixel to the planar texture. All the other pixels including the pixels in the non-selective rows and the pixels in the selective row but across the Data 0 columns are subject to the V_{N} pulse, 206, and hence the original state of these pixels is not altered by such low voltage pulse. Thus, a pixelized erasing has been achieved.

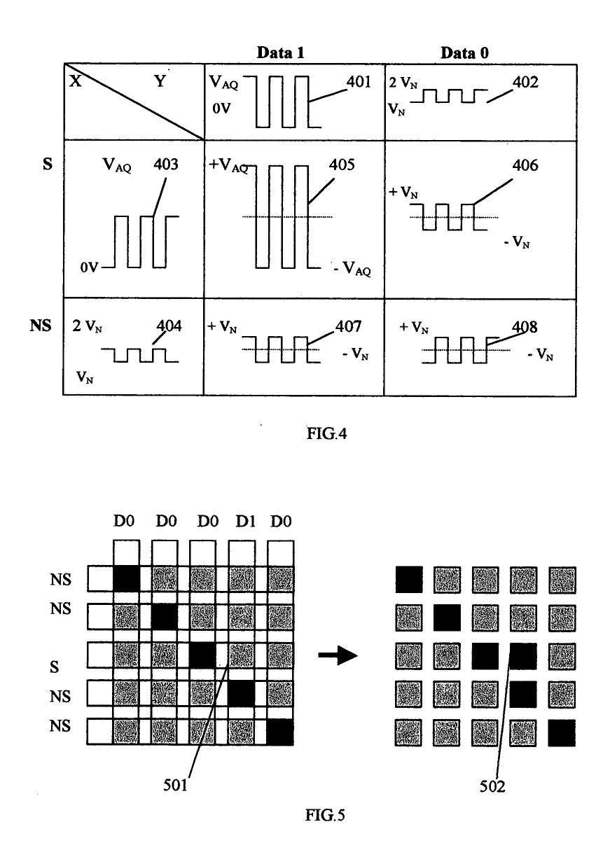

Turning now to the FIG. 3, illustrated is a 5×5 matrix structure of a cholesteric display. Even though an actual display could be a very complicated matrix patterning, such simple matrix structure is only for the purpose of explanation. There are 25 pixels in the matrix, wherein five pixels are preset in the focal conic texture, or in an optical dark black state and the rest twenty pixels are preset in the planar texture, or in the optical bright white state. The information on the display is a black “back-slash” line on a white background. In order to erase the center black pixel 301, D1 column and S row are subjected to the pulse 201 and 203 respectively. The voltage across the center pixel is the V_{ES} pulse, a result of the difference of 201 and 203. The focal conic texture of the center pixel is accordingly transformed into planar texture 302 via the field-induced-nematic phase change stage. All other pixels across D0 columns and NS rows will remain their original textures. The display result is then shown in the right portion of the FIG. 3. The simple and effective driving method, for the first time in history, achieves the pixelized erasing in a passive matrix display structure without any impact on the surrounding pixels. Turning now to FIG. 4, illustrated is the driving waveform of pixelized addressing of the present invention. There are two DC pulses generated from display's Y driver, Data 1, 401 and Data 0, 402. The amplitude of the Data I is equal to V_{AQ} and the width of it is kept constant at, for example, 2 ms while the duration of the pulses is 20 ms. The amplitude of the Data 0 is chosen between 2V_{N} and V_{N} and the width and the duration are the same as the Data 1. Both the Data 1 and 0 are led to column electrodes controlled by the Y driver. There are also two DC pulses generated from display's X driver connected to the row electrodes, Selected pulse, 403 and Non-selected pulse, 404. Selected pulse is chosen to be the same as the Data 1 pulse but kept in out-phase with the Data 1. Similarly, Non-selected pulse is chosen to be the same as the Data 0 pulse but kept in out-phase with the Data 0. Both the Selected pulse and Non-selected pulse are led to the row electrodes controlled by the X driver. The voltage across a pixel is the DC-free AC voltage resulting from the difference between the respective column and row. The voltage across the pixels in the selected row is V_{AQ} pulse, 405 or V_{N} pulse, 406. The voltage across the pixels in the non-selected row is V_{N} pulse, 406. As a result, the pixel across the Data 1 column and the selected row will be addressed to focal conic texture. In other word, the Data 1 DC waveform out of Y driver and the DC waveform on selected row are of the same pulse height but opposite in phase and composites a AC waveform 405 which drives the pixel from original planar texture to the focal conic texture, All other pixels including the pixels in the non-selective rows and the pixels in the selective row but across the Data 0 columns are subject to the V_{N} pulse, 406, and hence the original state of these pixels is not altered by such low voltage pulse. Thus, A pixelized addressing has been achieved. Turning now to the FIG. 5, illustrated is a 5×5 matrix structure of a cholesteric display. Even though an actual display could be a very complicated matrix patterning, such simple matrix structure is only for the purpose of explanation. There are 25 pixels in the matrix, wherein five pixels are preset in the focal conic texture, or in an optical dark black state and the rest twenty pixels are preset in the planar texture, or in the optical bright white state. The information on the display is a black “back-slash” line on a white background. In order to address the pixel in planar texture 501 across the second column from right and the center row, D1 column and S row are subjected to the pulse 401 and 403 respectively. The voltage across the addressing pixel is the V_{AQ} pulse, a result of the difference of 401 and 403. The planar texture of the pixel is accordingly transformed into focal conic texture 502 via a helical axis rotation process. All other pixels across D0 columns and NS rows will remain in their original textures. The display result is then shown in the right portion of the FIG. 5.

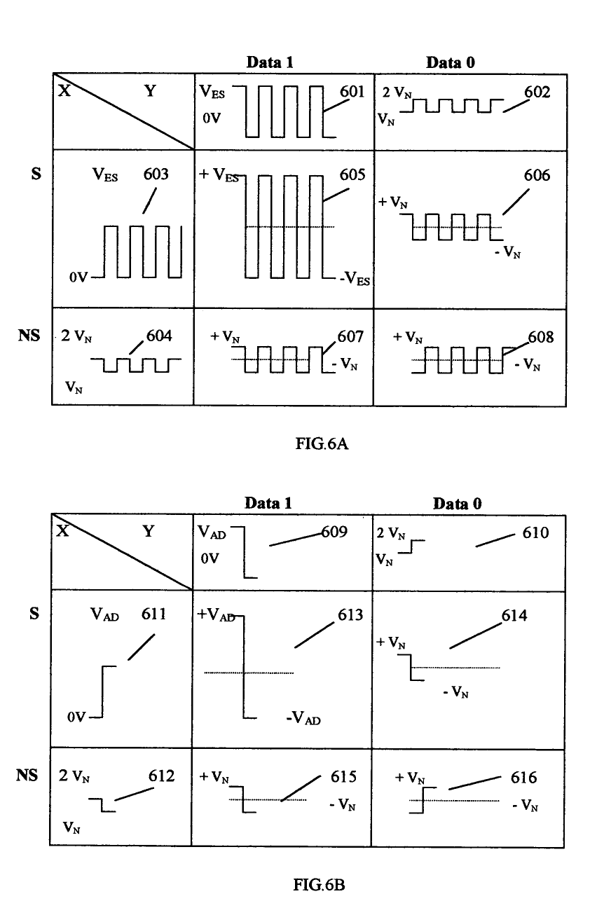

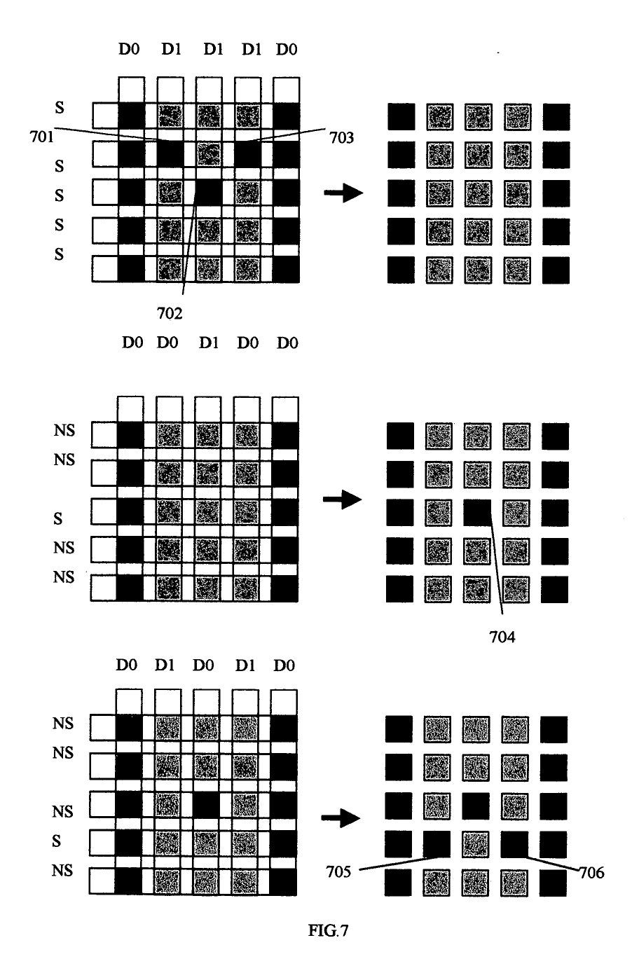

Turning now to FIG. 6, illustrated is the driving waveform of pixelized erasing and addressing of the present invention. FIG. 6A is a static erasing waveform similar to the FIG. 2. There are two DC pulses generated from display's Y driver, Data 1, 601 and Data 0, 602. The amplitude of the Data 1 is equal to V_{ES} and the width of it is kept constant at, for example, 2 ms while the duration of the pulses is 100 ms. The amplitude of the Data 0 is chosen between 2V_{N} and V_{N} and the width and the duration are the same as the Data 1. Both the Data 1 and 0 are led to column electrodes controlled by the Y driver. There are also two DC pulses generated from display's X driver connected to the row electrodes, Selected pulse, 603 and Non-selected pulse, 604. Selected pulse is chosen to be the same as the Data “1” pulse but kept in out-phase with the Data 1. Similarly, Non-selected pulse is chosen to be the same as the Data 0 pulse but kept in out-phase with the Data 0. Both the Selected pulse and Non-selected pulse are led to the row electrodes controlled by the X driver. The voltage across a pixel is the DC-free AC voltage resulting from the difference between the respective column and row. The voltage across the pixels in the selected row is either V_{ES} pulse, 605 or V_{N} pulse, 606. The voltage across the pixels in the non-selected row is V_{N} pulse, 606. As a result, the pixel across the Data 1 column and the selected row will be addressed to planar texture. In other word, The Data 1 DC waveform out of Y driver and the DC waveform on selected row are of the same pulse height but opposite in phase and composites a AC waveform 605 which drives the pixel to the planar texture, All the other pixels including the pixels in the non-selective rows and the pixels in the selective row but across the Data 0 columns are subject to the V_{N} pulse, 606, and hence the original state of these pixels is not altered by such low voltage pulse. Thus, A pixelized partial erasing has been achieved.

After the pixelized partial erasing, a pixelized line-to-line addressing is followed. FIG. 6B illustrates the driving waveform of pixelized addressing. There are two DC pulses generated from display's Y driver, Data 1, 609 and Data 0, 610. The amplitude of the Data 1 is equal to V_{AD} and the width of it is kept constant at, for example, 2 ms. The amplitude of the Data 0 is chosen between 2V_{N} and V_{N} and the width and the duration are the same as the Data 1. Both the Data 1 and 0 are led to column electrodes controlled by the Y driver. There are also two DC pulses generated from display's X driver connected to the row electrodes, Selected pulse, 611 and Non-selected pulse, 612. Selected pulse is chosen to be the same as the Data 1 pulse but kept in out-phase with the Data 1. Similarly, Non-selected pulse is chosen to be the same as the Data 0 pulse but kept in out-phase with the Data 0. Both the Selected pulse and Non-selected pulse are led to the row electrodes controlled by the X driver. The voltage across a pixel is the DC-free AC voltage resulting from the difference between the respective column and row. The voltage across the pixels in the selected row is either V_{AD} pulse, 613 or V_{N} pulse, 614. The voltage across the pixels in the non-selected row is V_{N} pulse, 615 and 616. As a result, the pixel across the Data 1 column and the selected row will be addressed to focal conic texture. In other word, The Data 1 DC waveform out of Y driver and the DC waveform on selected row are of the same pulse height but opposite in phase and composites a AC waveform 613 which drives the pixel from original planar texture to the focal conic texture, All other pixels including the pixels in the non-selective rows and the pixels in the selective row but across the Data 0 columns are subject to the V_{N} pulses, 614, 615, 616, and hence the original state of these pixels is not altered by such low voltage pulse. Thus, A pixelized addressing has been achieved.

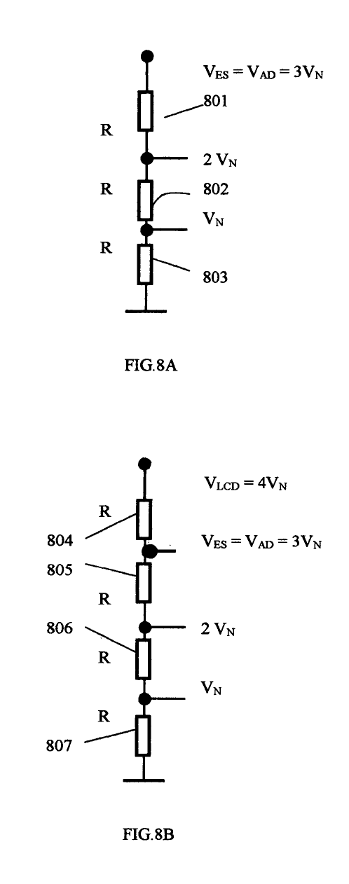

Turning now to the FIG. 7, illustrated is a 5×5 matrix structure of a cholesteric display. Even though an actual display could be a very complicated matrix patterning, such simple matrix structure is only for the purpose of explanation. The information on the display is a black “M” line on a white background. In order to address the 5×5 matrix into “W”, a driving scheme of pixelized partial erasing and pixelized line-to-line addressing is necessary. In the pixelized partial erasing, all the rows are in selective state and the first and the last columns are subjected to D0 pulses and the rest three middle columns to D1 pulses. The 15 pixels across D1 columns and Selected rows will tend to change their optical state to the planar texture via a dynamic relaxation no matter what the original state is. The pixels 701, 702 and 703 were in focal conic dark state originally and now become bright planar state.

During the course of the first relaxation, a pixelized line-to-line addressing is timely carried out. The dynamic-relaxation driving means, invented by the applicant has more detailed description of the line-to-line addressing after the erasing pulse.

First, The scanning selection pulse is set to the third row and the D1 signal to the third column respectively. The voltage across the center addressing pixel 704 is the V_{AD} pulse. The pixel 704 is accordingly transformed into focal conic texture via the second relaxation process. All the other pixels across D0 columns and NS rows will remain intact.

Then comes the second scanning line. The selective pulse now is applied to the fourth row and the D1 pulses to the second and fourth columns respectively. In the second scanning line, pixel 705 and pixel 706 located at the across-section of the selected pulse and D1 pulse will convert their current state dynamically into the focal conic texture. Meanwhile all the pixels across the non-selected row and D0 column will be relaxed into stable planar texture.

After the above-mentioned partial static erasing and line-to-line dynamic addressing, the display results in a character “W”.

Referring to FIG. 7, illustrated is power supply distribution circuitry. FIG. 7A shows a three-resistor circuit wherein V_{LCD} is the highest voltage of the LCD power source which is equal to the erasing voltage V_{ES} and addressing voltage V_{AD}. Three in-series resistors 801-803 are equal in value and the linear voltage distribution of those resistors results in V_{N}, 2V_{N}, 3V_{N}. Most importantly, the pulse number of V_{LCD} is programmed and digitized by a LCD controller, which differentiates the erasing pulse and addressing pulse. Such power supply, V_{LCD}, with the same pulse height but different pulse number is led to the distribution circuit. Each divided voltage terminal of the distribution circuitry will be connected to an operational amplifier and then to a logical circuitry of the X driver and the Y driver of the display.

FIG. 7B shows a four-resistor circuit wherein V_{LCD} is the highest voltage of the LCD power source and satisfied with the following equation
V_{LCD}=V_{ES}+V_{N}. (6)
Four in series resistors 804-807 are equal in resistivity value and the linear distribution of those resistors to the power supply V_{LCD} resulting in V_{N}, 2V_{N}, 3V_{N} and 4V_{N}. The non-addressing voltage, V_{N} is derived from the formula
3V_{N}−2V_{N}=V_{N} (7)
and the erasing voltage V_{ES} and the addressing voltage V_{AD} is derived from the formula
4V_{N}−V_{N}=3V_{N}=V_{ES}=V_{AD} (8)

1. A pixelized driving means for a cholesteric liquid crystal display comprising:
a. first iso-voltage pulse;
b. second iso-voltage pulse;
c. third iso-voltage pulse;
d. a bias voltage pulse;
the first, the second and the third iso-voltage pulses, having the same pulse-height but different pulse-width respectively and having a predetermined ratio in pulse-height to the bias pulse, applied to a predetermined location of the display properly, whereby at least a single pixel of the display can be independently activated to a designated optical state without substantial impact on the optical states of the neighborhood pixels of the display.

2. The driving means according to claim 1 wherein the first iso-voltage pulse is a static erasing pulse, V_{ES}, with its pulse-width wide enough to drive at least a single pixel into planar texture.

3. The driving means according to claim 1 wherein the second iso-voltage pulse is a quasi-static addressing pulse, V_{AQ}, with its pulse-width wide enough to drive at least a single pixel from planar texture into focal conic texture.

4. The driving means according to claim 1 wherein the third iso-voltage pulse is a short dynamic addressing pulse, V_{AD}, which combines with the first iso-voltage pulse to drive at least a single pixel into the focal conic texture during the course of the dynamic relaxation initiated by the first iso-voltage pulse.

5. The driving means according to claim 1 wherein the three iso-voltage pulses are satisfied with the following conditions:
V_{AD}=V_{AQ}=V_{ES},
P_{ES}>P_{AQ}>P_{AD}.

6. The driving means according to claim 5 wherein P_{ES} represents the pulse-width of the static erasing pulse within a range of 50˜500 ms and more preferably 0.5˜2 ms.

7. The driving means according to claim 5 wherein P_{AQ} represents the pulse-width of the quasi-static addressing pulse within a range of 20˜50 ms.

8. The driving means according to claim 5 wherein PAD represents the pulse-width of the dynamic addressing pulse within a range of 0.05˜5 ms and more preferably 0.5˜2 ms.

9. The driving means according to claim 1 wherein the predetermined ratio of the iso-voltage pulses to the bias pulse, V_{N}, is 3:1, i.e.,
V_{AD}=V_{AQ}=V_{ES}=3V_{N}.

10. The driving means according to claim 1 wherein the bias voltage pulse is satisfied with the following condition:
V_{N}=V_{T},
where V_{T} represents the field-induced rotational threshold voltage.

11. A pulse-number modulation devise for the pixelized driving means comprising:
a. a digitized pulse controller;
b. an unit pulse generator;
wherein all the pulses, required for the pixelized driving means, being made of integral numbers of an unit pulse-width out of the pulse generator, wherein the first, the second and the third pulses, having the same pulse-height, same pulse width but different pulse number are applied to a predetermined location of the display properly, whereby the optical states of every single pixel of the display can be digitally controlled.

12. The pulse-number modulation devise according to the claim 11 wherein the same pulse-width means a unit of pulse-width for all the functional pulses of the pixelized driving means.

13. The pulse-number modulation devise according to the claim 12 wherein the unit pulse-width is equivalent to the pulse-width of the dynamic addressing pulse.

14. The pulse-number modulation devise according to the claim 12 wherein the unit of pulse-width is a sub-division of the dynamic addressing pulse, whereby a gray scale can be achieved by the multiplication of the sub-divisional pulse.

15. The pulse-number modulation devise according to the claim 11 wherein the same pulse-height means that the addressing voltage and erasing voltage are of the same amplitude.

16. A waveform generating circuitry for pixelized driving means comprising:
a. a DC pulse voltage source, V_{LCD};
b. a three-resistor divider circuit;
c. a X driver circuit;
d. a Y driver circuit;
e. a matrix display structure;
V_{LCD} being the highest voltage of the LCD power source and equivalent to the erasing voltage V_{ES} and addressing voltage V_{AD}, Three in-series resistors being equal in value and the linear voltage distribution of those resistors resulting in multiple outputs, Each divided voltage terminal of the distribution circuitry being connected to an operational amplifier and then to a logical circuitry of the X driver and the Y driver of the display,
(1) wherein a DC-free AC erasing pulse synthesized by the X driver and Y driver apples on at least single pixel of the matrix display structure, while all the other pixels, including the non-selective row and selective row but data 0 column, are subjected to bias voltage V_{N}, whereby the pixelized erasing is achieved,
(2) wherein a DC-free AC addressing pulse synthesized by the X driver and Y driver apples on at least single pixel of the display, while all the other pixels, including the non-selective rows and selective row but data 0 column, are subjected to bias voltage V_{N}, whereby the pixelized addressing is achieved.

17. The waveform generating circuit according to claim 16 wherein the multiple outputs are V_{N}, 2V_{N} and V_{LCD}.

18. The waveform generating circuit according to claim 16 wherein the waveform is governed by the following formula
V_{LCD}=V_{AD}=V_{AQ}=V_{ES}=3V_{N}

19. The waveform generating circuit according to claim 16 further including a four-resistor divider circuit and related multiple outputs.

20. The waveform generating circuit according to claim 19 wherein the multiple outputs are V_{N},2V_{N}, 3V_{N} and V_{LCD}.

21. The waveform generating circuit according to claim 19 wherein the waveform is governed by the following formula
V_{AD}=V_{AQ}=V_{ES}=3V_{N}=V_{LCD}−V_{N}.
